(19) United States
(12) Patent Application Publication
(10) Pub. No.: US 2024/0397482 A1
(43) Pub. Date: Nov. 28, 2024

(54) TERMINAL, BASE STATION, AND WIRELESS COMMUNICATION METHOD

(71) Applicants: DENSO CORPORATION, Kariya-City (JP); TOYOTA JIDOSHA KABUSHIKI KAISHA, Toyota-shi (JP)

(72) Inventors: Tatsuki NAGANO, Kariya-City (JP); Hideaki TAKAHASHI, Kariya-City (JP)

(21) Appl. No.: 18/794,998

(22) Filed: Aug. 5, 2024

Related U.S. Application Data
(63) Continuation of application No. PCT/JP2023/003687, filed on Feb. 6, 2023.

(30) Foreign Application Priority Data
Feb. 9, 2022 (JP) 2022-018558

(51) Int. Cl. H04W 68/02; H04W 76/27

(52) U.S. Cl. CPC H04W 68/025; H04W 76/27

(57) ABSTRACT

A terminal includes a reception unit that receives system information and receives a radio resource control (RRC) release message and a control unit that stores a serving cell as a last used cell in a case in which the RRC release message is received. The control unit controls to monitor a physical downlink control channel (PDCCH) for paging early indication in the last used cell based on information about a cell to which the paging early indication included in paging early indication (PEI) configuration information in the system information is transmitted.

### CROSS-REFERENCE TO RELATED APPLICATION

This application is a continuation application of International Patent Application No. PCT/JP2023/003687, filed Feb. 6, 2023, which designated the U.S. and claims the benefit of priority to Japanese Patent Application No. 2022-018558, filed on Feb. 9, 2022. The entire disclosures of the above application are incorporated herein by reference.

### TECHNICAL FIELD

The present disclosure relates to a terminal, a base station, and a communication method.

### BACKGROUND

In the Third Generation Partnership Project (3GPP) as an international standards organization, New Radio (NR) Release 15 as the 5th generation (5G) Radio Access Technology (RAT) is specified as a successor to Long Term Evolution (LTE) as the 3.9th generation RAT and LTE-Advanced as the 4th generation RAT, for example, 3GPP TS 38.300 V15.2.0 (2018-06). LTE and/or LTE-Advanced is also called evolved universal terrestrial radio access (E-UTRA).

### SUMMARY

### Technical Problem

In NR, a terminal can monitor downlink control information (DLCI) (hereinafter, referred to as a “paging DCI”) including information about scheduling of a downlink shared channel (for example, a physical downlink shared channel (PDSCH)) for transmitting a paging message and/or information about a short message in a given period called a paging occasion (PO) or the like, and receive the paging message and/or the short message based on the detected paging DCI.

Currently, 3GPP is studying a technique of informing the terminal of information (hereinafter, referred to as “paging early indication (PEI) information” or “first information”) about the paging in one or a plurality of POs and controlling the terminal operation in the PO based on the PEI information.

An object of the present disclosure is to provide a terminal, a base station, and a wireless communication method with which transmission and reception of PEI information can be appropriately controlled.

According to one aspect of the present disclosure, there is provided a terminal including: a reception unit configured to receive system information and receive a radio resource control (RRC) release message; and a control unit configured to store a serving cell as a last used cell in a case in which the RRC release message is received, in which the control unit controls to monitor a physical downlink control channel (PDCCH) for paging early indication in the last used cell based on information about a cell to which the paging early indication included in paging early indication (PEI) configuration information in the system information is transmitted.

According to the present disclosure, the transmission and reception of the PEI information can be appropriately controlled.

### BRIEF DESCRIPTION OF DRAWINGS

FIG. 1 is a diagram illustrating an example of the overview of a wireless communication system according to the present embodiment.

FIG. 2 is a diagram illustrating an example of a PO according to the present embodiment.

FIG. 3 is a diagram illustrating an example of a relationship between a PEI-O and the PO according to the present embodiment.

FIG. 4 is a diagram illustrating a transmission method of a PEI transmission area information by system information.

FIG. 5 is a sequence diagram illustrating an example of a processing procedure performed by a terminal 10 and a base station 20.

FIG. 6 is a diagram illustrating a specification change example (1) of a 3GPP specification (TS38.304).

FIG. 7 is a diagram illustrating a specification change example (2) of the 3GPP specification (TS38.304).

FIG. 8 is a diagram illustrating a specification change example of a 3GPP specification (TS38.331).

FIG. 9 is a diagram illustrating a specification change example of the 3GPP specification (TS38.331).

FIG. 10 is a diagram illustrating an example of a hardware configuration of each apparatus in the wireless communication system according to the present embodiment.

FIG. 11 is a diagram illustrating an example of a functional configuration of the terminal according to the present embodiment.

FIG. 12 is a diagram illustrating a functional block configuration of a base station according to the present embodiment.

### DETAILED DESCRIPTION

Hereinafter, the present embodiment will be described with reference to the accompanying drawings. For easy understanding of the description, the same constituents in each drawing will be assigned the same reference signs as much as possible, and duplicate descriptions will be omitted.

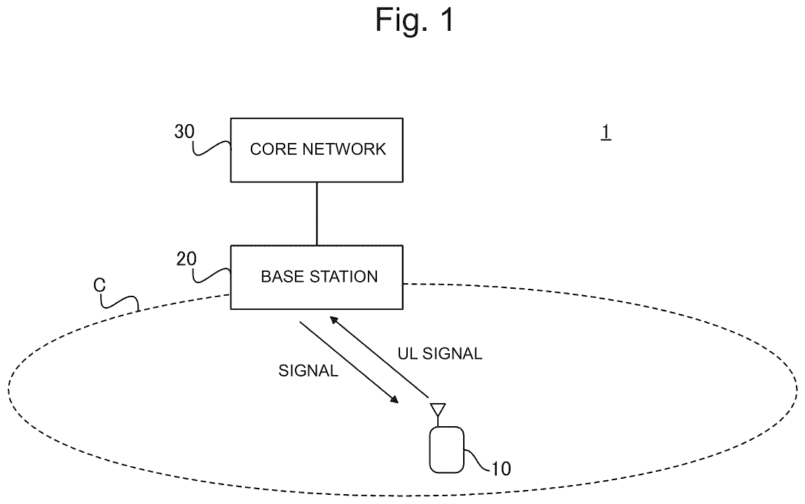

FIG. 1 is a diagram illustrating an example of the overview of a wireless communication system according to the present embodiment. As illustrated in FIG. 1, a wireless communication system 1 may include a terminal 10, a base station 20, and a core network 30. The number of terminals 10 and the number of base stations 20 illustrated in FIG. 1 are merely an example and are not limited to the illustrated numbers.

The wireless communication system 1 is a system that performs communication by complying with a radio access technology (RAT) defined by 3GPP. The radio access technology with which the wireless communication system 1 complies is assumed to be, for example, but is not limited to, a fifth generation RAT such as NR. For example, one or a plurality of RATs such as a fourth generation RAT such as LTE and LTE-Advanced and a non-3GPP RAT such as an RAT of a sixth generation or later and Wi-Fi (registered trademark) can be used. The wireless communication system 1 may be in the form of performing communication by complying with a radio access technology defined by a standard-setting body (for example, Institute of Electrical and Electronics Engineers (IEEE) and Internet Engineering Task Force (IETF)) different from 3GPP.

The terminal 10 is an apparatus corresponding to a terminal (for example, user equipment (UE)) defined in the 3GPP specification. The terminal 10 is, for example, a given terminal or apparatus such as a smartphone, a personal computer, a vehicle, a vehicle-mounted terminal, a vehicle-mounted apparatus, a stationary apparatus, a telematics control unit (TCU), and an IoT device such as a sensor. The terminal 10 may be called user equipment (UE), a mobile station (MS), a user terminal, a radio apparatus, a subscriber terminal, an access terminal, or the like. In addition, the terminal 10 may be a so-called reduced capability (RedCap) terminal and may be, for example, an industrial wireless sensor, a video surveillance camera, or a wearable device. The terminal 10 may be of a mobile type or a fixed type. For example, the terminal 10 is configured to be capable of performing communication using one or a plurality of RATs such as NR, LTE, LTE-Advanced, and Wi-Fi (registered trademark). The terminal 10 is not limited to a terminal defined in the 3GPP specification and may be a terminal complying with a standard defined by other standard-setting bodies. In addition, the terminal 10 may not be a terminal complying with a standard.

The base station 20 is an apparatus corresponding to a base station (for example, a gNodeB (gNB) or an E-UTRAN NodeB (eNB)) defined in a 3GPP specification. The base station 20 forms one or more cells C and communicates with the terminal 10 using the cell. The cell C may be replaced with a serving cell, a carrier, a component carrier (CC), or the like. In addition, the cell C may have a given bandwidth. For example, the base station 20 may communicate with the terminal 10 using one or more cell groups. Each cell group may include one or more cells C. Unifying a plurality of cells C in a cell group is called carrier aggregation. The plurality of cells C may include a primary cell (PCell) or a primary secondary cell group (SCG) cell (PSCell), and one or more secondary cells (SCGs). In addition, communicating with the terminal 10 using two cell groups is called dual connectivity. The terminal 10 is not limited to a base station defined in the 3GPP specification and may be a terminal complying with a standard defined by other standard-setting bodies. In addition, the terminal 10 may not be a base station complying with a standard.

The base station 20 may be referred to as a gNodeB (gNB), an en-gNB, a next-generation eNB (ng-eNB), a next generation-radio access network (NG-RAN) node, a low-power node, a central unit (CU), a distributed unit (DU), a gNB-DU, a baseband unit (BBU), a remote radio head (RRH), an integrated access and backhaul/backhauling (IAB) node, an access point, or the like. The base station 20 is not limited to one node and may be configured with a plurality of nodes (for example, a combination of a lower node such as a DU and a higher node such as a CU). The base station 20 may be connected to each other via a given interface (for example, an Xn interface).

The core network 30 is, for example, but is not limited to, a fifth generation core network (5G core network (5GC)) or a fourth generation core network (evolved packet core (EPC)). An apparatus on the core network 30 (hereinafter, referred to as a “core network apparatus”) may perform mobility management such as paging and location registration of the terminal 10. The core network apparatus may be connected to the base station 20 or to the terminal 10 through a given interface (for example, an S1 or NG interface).

The core network apparatus may include, for example, at least one of an access and mobility management function (AMF) of managing information about a C plane (for example, information about access, mobility management, and the like) or a user plane function (UPF) of performing a transmission control of information about a U plane (for example, user data).

In the wireless communication system 1, the terminal 10 receives a downlink (DL) signal from the base station 20 and/or transmits an uplink (UL) signal to the base station 20. In the terminal 10, one or more cells C are configured, and at least one of the configured cells is activated. The maximum bandwidth of each cell is, for example, 20 MHz or 400 MHz.

In addition, the terminal 10 performs a cell search based on a synchronization signal (for example, a primary synchronization signal (PSS) and/or a secondary synchronization signal (SSS)) from the base station 20. The cell search is a procedure for the terminal 10 to acquire time and frequency synchronization with the cell and detect an identifier (for example, a physical layer cell ID) of the cell.

The terminal 10 determines a search space set and/or a control resource set (CORESET) based on parameters (hereinafter, referred to as “RRC parameters”) included in a radio resource control (RRC) message. The CORESET may be configured with a frequency domain resource (for example, a given number of resource blocks) and a time domain resource (for example, a given number of symbols). The RRC parameters may be called RRC information elements (IEs) or the like.

The terminal 10 performs monitoring of downlink control information (DCI) transmitted through a downlink control channel (for example, a physical downlink control channel (PDCCH)) in the search space set associated with the CORESET. The RRC message may include, for example, an RRC setup message, an RRC reconfiguration message, an RRC resume message, an RRC reestablishment message, and system information. Hereinafter, the downlink control channel will be referred to as a PDCCH, but may be referred to as another name.

Monitoring of the DCI means blind decoding of PDCCH candidates in the search space set with an assumed DCI format by the terminal 10. The number of bits (referred to as a size, a bit width, or the like) of the DCI format is set in advance or derived in accordance with the number of bits of fields included in the DCI format. The terminal 10 detects the DCI for the terminal 10 based on the number of bits of the DCI format and on a specific radio network temporary identifier (RNTI) used for scrambling a cyclic redundancy check (CRC) bit (referred to as a CRC parity bit) of the DCI format (hereinafter, referred to as “CRC scrambling”). Monitoring of the DCI is called PDCCH monitoring, a PDCCH monitor, or the like. In addition, a given period for monitoring the DCI or the PDCCH is called a PDCCH monitoring occasion.

The terminal 10 monitors the PDCCH using the search space set in the PDCCH monitoring occasion, and receives (or detects) the DCI scrambled with the CRC by the specific RNTI (for example, the P-RNTI, the cell (C)-RNTI, or the like). The terminal 10 controls reception of a downlink shared channel (for example, a physical downlink shared channel (PDSCH)) scheduled using the DCI and/or transmission of an uplink shared channel (for example, a physical uplink shared channel (PUSCH)) scheduled using the DCI. Hereinafter, the downlink shared channel and the uplink shared channel are referred to as the PDSCH and the PUSCH, but may be referred to as other names.

The search space set is a set of one or more search spaces and may include a search space set (hereinafter, referred to as a “common search space (CSS) set”) to be used in common between one or more terminals 10 and a terminal-specific search space set (UE-specific search space (USS) set). The terminal 10 receives information about configuration of each search space set, and configures each search space set based on the information about the configuration.

For example, the terminal 10 may receive information (hereinafter, referred to as “paging search space configuration information”, for example, the RRC parameter “pagingSearchSpace”) about configuration of search space set for paging (hereinafter, referred to as “paging search space”), and may configure a paging search space (for example, a Type2-PDCCH CSS set) based on the information. The terminal 10 may detect the DCI scrambled with the CRC by a specific RNTI (for example, “paging (P)-RNTI”).

The terminal 10 receives the paging message via the PDSCH scheduled by using the DCI. Here, the information indicating the P-RNTI may be configured by a given value. Hereinafter, the paging DCI may be a DCI scrambled with the CRC by the P-RNTI. The format of the DCI may be, for example, DCI format 1_0. In addition, the terminal 10 may receive a short message based on the paging DCI.

The system information broadcasted by the cell C may include a master information block (MIB) and/or one or more system information blocks (SIBs). The MIB is broadcasted through a broadcast channel (for example, a physical broadcast channel (PBCH)). The MIB and an SIB1 are called minimum system information, and the SIB1 is called remaining minimum system information (RMSI). An SIBx (x is any character string such as x=2, 3, . . . ) other than the SIB1 is called other system information (OSI). The SIB1 and the SIBx other than the SIB1 are broadcasted through the PDSCH. The SIB1 may be cell-specific, and the SIBx other than the SIB1 may be cell-specific or specific to an area including one or more cells.

A block including at least one of the synchronization signal, the PBCH, or the demodulation reference signal (DM-RS) for the PBCH is referred to as a synchronization signal block (SSB). The SSB may be called an SS/PBCH block, an SS block, or the like. The SSB may be configured with a given number of symbols (for example, four consecutive symbols) as the time domain resource and a given number of subcarriers (for example, 240 consecutive subcarriers) as the frequency domain resource.

An SS burst set which is a set of one or more SSBs is transmitted with a given period. The SS burst set may be called an SS burst or the like. Each SSB in the SS burst set is identified by an index (hereinafter, referred to as an “SSB index”). In the case of multi-beam operation, SSBs having different indexes in the SS burst set correspond to different beams and may be transmitted by sequentially switching a beam direction via beam sweeping. In the case of single-beam operation, an SSB (one or a plurality of SSBs) having a specific index in the SS burst set may be transmitted in all directions.

### Paging

The paging is used to set up a connection in a network-leading manner in a case in which the terminal 10 is in an idle state or an inactive state. In addition, the paging is also used for transmitting a short message. The short message may be used to issue an instruction to update the system information and/or to issue a public warning system (PWS). In addition, the short message may be informed in any case of a state of the terminal 10. The PWS is, for example, an earthquake and tsunami warning system (ETWS), a commercial mobile alert system (CMAS), or the like.

Here, the idle state is a state in which a connection (hereinafter, referred to as “RRC connection”) of the RRC layer between the terminal 10 and the base station 20 is not established, and is also referred to as RRC_IDLE, an idle mode, an RRC idle mode, and the like. The terminal 10 in the idle state receives the system information, the short message, and the paging message by monitoring a control channel in the serving cell. When the RRC connection is established, the terminal 10 in the idle state transitions to the connected state.

Further, the inactive state is a state where the RRC connection is established but is suspended and is also called an RRC_inactive state, an inactive mode, an RRC inactive mode, and the like. The terminal 10 in the inactive state receives the system information, the short message, and the paging message by monitoring the control channel in the serving cell. When the RRC connection is resumed, the terminal 10 in the inactive state transitions to the connected state, and when the RRC connection is released, the terminal 10 transitions to the idle state.

The connected state is a state where the RRC connection is established and is also called an RRC_CONNECTED state, a connected mode, an RRC connected mode, and the like. The terminal 10 in a connected state performs various types of data transmission and reception including the system information and the short message in the serving cell. When the RRC connection is released, the terminal 10 in the connected state transitions to the idle state, and when the RRC connection is suspended, the terminal 10 transitions to the inactive state.

The terminal 10 in the idle state and the terminal 10 in the inactive state perform cell selection to serve in the suitable cell discovered. In addition, in a case in which the terminal 10 discovers a cell (more suitable cell) that fulfills the cell reselection criterion in accordance with the cell reselection criterion, the terminal 10 serves in the cell.

It should be noted that the term “serving” may be referred to as “camping”. For example, “serving in a cell” may be referred to as “camp on a cell”. In addition, the “serving cell” may be referred to as a “camping cell”, a “synchronized cell”, a “serving cell”, a “cell configured in the terminal 10”, or the like.

In a case where it is necessary to transmit a message to the terminal 10 in an idle state, the network (for example, the base station 20 and/or the core network 30) may transmit the short message or the paging message in a set of cells in an area of a given range including the serving cell in which the terminal 10 serves. The area in the given range may be referred to as a tracking area (TA). In addition, in a case in which it is necessary to transmit a message to the terminal 10 in an inactive state, the network (for example, the base station 20 and/or the core network 30) may transmit the paging message in each cell of the RAN notification area (RNA) in which the terminal 10 serves. The network (for example, the base station 20 and/or the core network 30) may, for example, transmit the paging message in a cell in which the terminal 10 has last established the RRC connection, and transmit the paging message in another cell in the set of the TA or the RNA in a case in which there is no response from the terminal 10 in the cell.

One or a plurality of cells are associated with TA. The TA is identified by a tracking area identifier (TAI). In addition, the TAI may be a combination of an identifier (mobile country code: MCC) indicating a country, an identifier (mobile network code: MNC) for identifying a network, and an identifier (tracking area code: TAC) for identifying a tracking area. The core network 30 may manage a registration area of the terminal 10 in units of sets of TAs.

In a case in which the core network 30 (for example, AMF) performs a registration procedure with the terminal 10, a TAI list indicating the set of TAs is allocated to the terminal 10 as the registration area. The TAI list includes at least the TAI of the TA corresponding to the cell in which the terminal 10 serves. When the terminal 10 in the idle state is within the area configured by the TAI list, the terminal 10 can move without informing the core network 30 of the serving TA. In addition, in a case in which the TAI (current TAI) of the serving cell is not in the TAI list, the terminal 10 performs a mobility registration update procedure to inform the core network 30 (for example, the AMF) that the terminal 10 has moved outside the TAI list (that is, has moved outside the registration area). The core network 30 that has received the inform updates the TAI list of the terminal 10.

The RNA covers one or a plurality of cells and may be included in a registration area (that is, a set of TAs) in the core network 30. That is, the RNA may be an area in which the registration area is subdivided, or may be the same as the registration area in the core network 30. In addition, the RNA may be configured by a list of one or a plurality of cells, or may be configured by a list of at least one RAN area. The RAN area may be a subset of the TA or may be the same as the TA.

Information indicating the range of the RNA is configured in the terminal 10 from the base station 20 in a case in which the terminal 10 transitions to the inactive state. When the terminal 10 in the inactive state is within the area configured by the RNA, the terminal 10 can move without informing the base station 20 of the serving cell. The terminal 10 transmits an RNA update (RAN-based notification area update) to the base station 20 in a case in which the cell that does not belong to the RNA configured in the terminal 10 is selected in the cell reselection procedure and periodically. In a case in which the base station 20 (also referred to as a “last serving gNB”) that has issued an instruction to transition the terminal 10 to the inactive state receives a signal related to the terminal 10 from the core network 30, the base station 20 performs the paging in the cell corresponding to the RNA. In addition, in a case in which the cell of another base station 20 (also referred to as a neighboring base station 20) is included in the RNA, the base station 20 may transmit the RAN paging message to the other base station 20 in order to perform the paging of the other base station 20. The terminal 10 in the inactive state that has received the paging signal resumes the RRC connection and transitions to the connected state.

The paging initiated by the core network 30 and performed on the terminal 10 in the idle state may be referred to as “CN paging”. The paging initiated by the base station 20 with respect to the terminal 10 in the inactive state may be referred to as “RAN paging”.

The system information (for example, SIB1) may include an identifier of the tracking area (for example, TAC), an identifier of the RAN area (for example, RAN-AreaCode), and a cell identifier (CellIdentity). That is, the terminal 10 can identify the TA of the cell in which the terminal 10 servers and the RAN area by receiving the system information.

The terminal 10 performs discontinuous reception (DRX) in order to reduce power consumption. Specifically, the terminal 10 can perform the PDCCH monitoring on a paging occasion (PO) and can be in a sleep state in a period other than the PO.

The PO is a given period configured by one or more time units (for example, one or more symbols, one or more slots, or one or more subframes). The PO may be configured of, for example, one or more sets of PDCCH monitoring occasions. The PO may be provided at a given period. The PO may be provided in a paging frame (PF). A radio frame (RF) configuring the PF is a given time unit (for example, a time unit configured by 10 subframes) and is identified by an identification number (hereinafter, referred to as a “system frame number (SFN)”). One or a plurality of PFs may be provided in a DRX period. The DRX period is also referred to as a paging cycle.

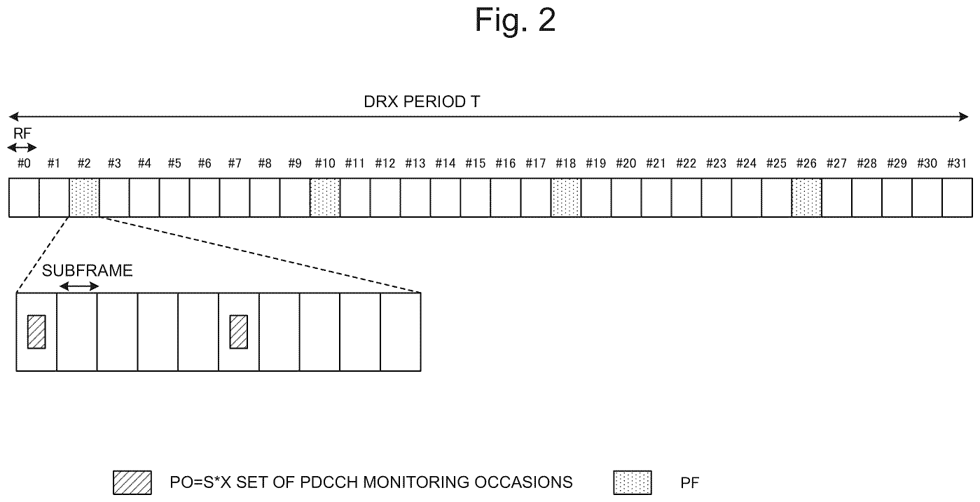

FIG. 2 is a diagram illustrating an example of a PO according to the present embodiment. As illustrated in FIG. 2, the PF is disposed for every given number of RF (here, 8 RF) in the DRX period (here, 32 RF).

The terminal 10 controls the establishment of the connection with the network side (for example, the base station 20 and/or the core network 30) based on a list (for example, the RRC parameter “paging RecordList”) of one or more terminal identifiers in the paging message received by the PO and the terminal identifier assigned to the terminal 10. For example, in a case in which the list includes the terminal identifier assigned to the terminal 10, the terminal 10 may start a procedure of establishing a connection with the network side. Here, the terminal identifier is an identifier of the terminal 10, and may be, for example, a 5G-S-TMSI or may be determined based on the 5G-S-TMSI.

In the terminal 10, even in a case in which the paging DCI is received, it is not possible to discriminate which paging is for which terminal 10 without decoding the list of the terminal identifiers in the paging message. Therefore, the terminal 10 needs to perform processing of discriminating whether or not the paging for the terminal 10 is performed for each PO. As a result, the terminal 10 that is not the paging target may consume power unnecessarily.

### PEI

Currently, in 3GPP, in order to reduce the waste of power consumption of the terminal 10 that is not a paging target, it is considered to inform the terminal 10 of the PEI information about the paging in one or a plurality of POs and control the terminal operation in the PO based on the PEI information. For example, it is considered that a group configured of a plurality of terminals 10 using the same PO is divided into a plurality of sub-groups, and information (hereinafter, referred to as “sub-group information”) about the sub-groups that are the paging targets in the PO is included in the PEI information.

The sub-grouping of the terminals 10 may be performed based on the terminal identifier base, or may be executed based on the network. The PEI information may be referred to as “PEI”.

In a case of the terminal identifier base, the terminal 10 may determine the sub-group assigned to the terminal 10 based on the terminal identifier or the UE_ID. Specifically, the terminal 10 may determine an identifier (hereinafter, referred to as a “sub-group ID”) of the sub-group based on at least one of the PF number N, the PO number Ns per PF, or the total number Nsg of the sub-groups in the DRX period T in addition to the terminal identifier.

Meanwhile, in a case of the network-based, the base station 20 or the core network 30 may determine the sub-group to be allocated to the terminal 10 based on information (for example, the mobility state and the paging probability of the terminal 10, the power consumption profile of the terminal 10, the attribute of the terminal 10 related to the movement amount, and the like) managed on the network side. The base station 20 or the core network 30 may inform the terminal 10 of information (for example, a sub-group ID) indicating the determined sub-group by a network access stratum (NAS) message, an RRC message, or the like.

The sub-group information may be, for example, information (for example, a value of 1 bit) indicating whether or not the paging is performed for each sub-group (that is, which of the paging for each sub-group or the paging for each group is performed). Alternatively, the sub-group information may be information (hereinafter, referred to as “paging sub-group indication information”) indicating which sub-group is the paging target in one or a plurality of POs. One or a plurality of POs may be included in a single PF, or may be included in a plurality of PFs. For example, the PEI may correspond to a maximum of four POs in 1 PF.

For example, the paging sub-group indication information may indicate whether or not each sub-group is the paging target (presence or absence of a paging message for each sub-group) in each PO by dividing the terminal 10 that shares each PO into a given number of sub-groups (for example, a maximum of 8 sub-groups). The paging sub-group indication information may be, for example, a bitmap having the number of bits corresponding to the number of sub-groups of one or a plurality of POs, or information indicating an identifier of the sub-group that is a paging target in each PO.

The PEI information may be included in the DCI transmitted by the PDCCH.

The DCI including the PEI information is also referred to as “PEI DCI”, “first downlink control information”, or the like. The PEI DCI may include information about the short message in addition to the PEI information. The PEI DCI may be a DCI format 2_7.

The terminal 10 may determine that the time location of the PDCCH monitoring occasion for the PEI DCI (hereinafter, referred to as “PEI-O”) is a time location at which the PEI DCI is detected by the PEI-O and the PO indicating which sub-group is the paging target (hereinafter, referred to as “target PO”). For example, the time location of the PEI-O may be determined based on a time offset (for example, a frame level time offset) with respect to the PF including the target PO. Alternatively, the time location of the PEI-O may be determined based on the SSB or the SS burst before the target PO. The SS burst may be, for example, an L (for example, L=1, 2, or 3)th SS burst before the first PDCCH monitoring occasion before the PO. Alternatively, the time location of the PEI-O may be determined based on a time offset with respect to the target PO.

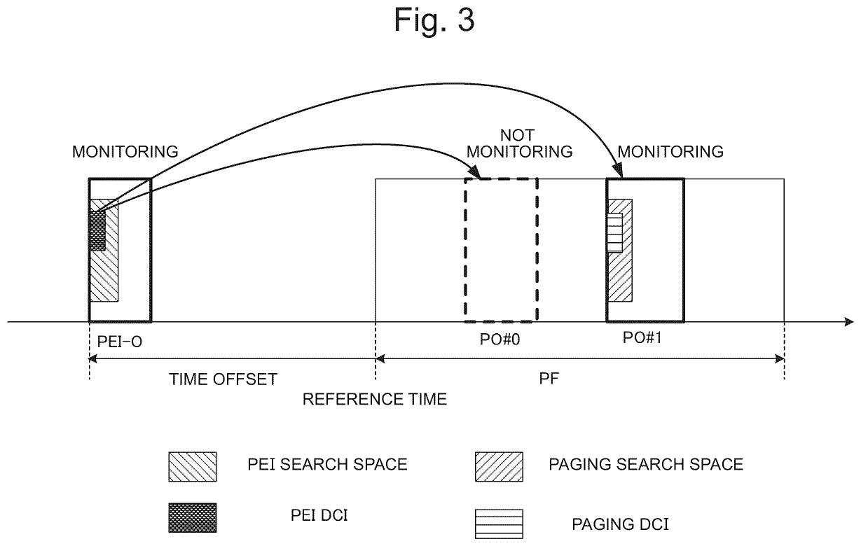

FIG. 3 is a diagram illustrating an example of a relationship between the PEI-O and the PO according to the present embodiment. As illustrated in FIG. 3, the PEI-O may be provided with a search space set (hereinafter, referred to as “PEI search space”) used for monitoring of the PEI DCI. The PEI DCI detected by monitoring the PEI search space may correspond to one or a plurality of POs (for example, a maximum of 4 POs per 1 PF). One PEI DCI may correspond to a plurality of POs across a plurality of PFs, or may correspond to one or a plurality of POs in one PF. In addition, a plurality of PEI DCI may correspond to one PO.

For example, in FIG. 3, the start timing of the PEI-O is determined by using a time offset (for example, the time offset of the RF level) with respect to a reference time with the start timing of the PF including the PO #0 and #1 as the reference time.

In FIG. 3, the terminal 10 in the idle state or the inactive state detects the PEI DCI by monitoring the PEI search space. The terminal 10 skips the monitoring of the paging search space in PO #0 based on the sub-group information in the PEI·DCI. Meanwhile, the terminal 10 monitors the paging DCI (also referred to as “second downlink control information”) in the paging search space in PO #1 based on the sub-group information in the PEI DCI.

The PEI information is not information indicating the presence or absence of the paging for each sub-group, and may be simply information indicating the presence or absence of the paging. For example, the sub-grouping of the terminal 10 may be optional, not mandatory. In a case in which the terminal 10 is not sub-grouped, the PEI information may be information indicating whether or not the paging message is transmitted by one or a plurality of POs associated with the PEI information. In addition, in a case in which the PEI information is received, the terminal 10 may skip the monitoring of the paging DCI in the paging search space in one or a plurality of POs associated with the received PEI information.

As described above, since the terminal 10 that has received the PEI information can skip the monitoring of the paging DCI in the PO, it is possible to reduce the power consumption of the terminal 10. Meanwhile, in addition to the paging in the related art, the base station 20 transmits the PEI information in the PEI-O before the PO, so that the consumption amount of the wireless resource is increased. In addition, the paging is performed for each cell included in the TAI list or the RNA in which the terminal 10 serves, but in a case in which the PEI information is transmitted by the plurality of cells each time the paging is performed, the consumption amount of the wireless resource is further increased. Therefore, in order to solve such a problem, it is desired to appropriately control the transmission and reception of the PEI information in consideration of the balance between the reduction in power consumption of the terminal 10 and the increase in the consumption amount of the wireless resource.

Therefore, in the present embodiment, information (hereinafter, referred to as “PEI transmission area information”) about the cell to which the PEI information is transmitted is configured in the terminal 10, and the terminal 10 controls which cell the PEI information is monitored in accordance with the information. In addition, the base station 20 controls whether or not to transmit the PEI information in a case of performing the paging in response to the information.

### Transmission of PEI Transmission Area Information by System Information

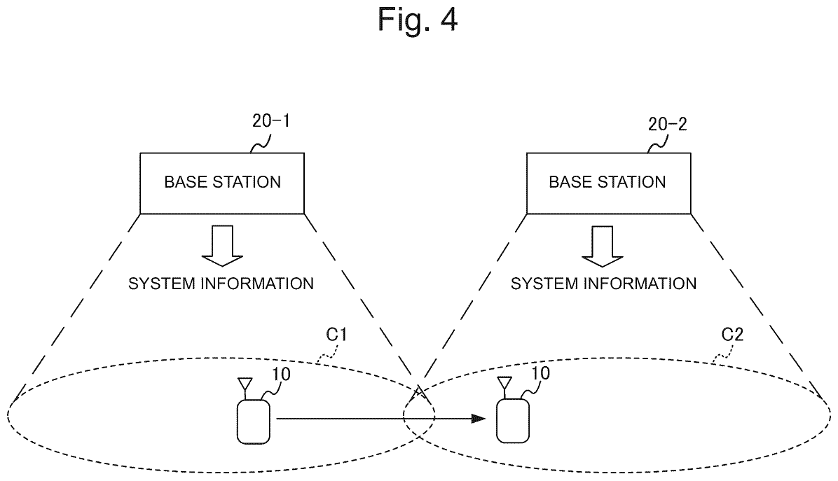

FIG. 4 is a diagram illustrating a transmission method of the PEI transmission area information by the system information. A base station 20-1 (first base station) and a base station 20-2 (second base station) that support the transmission of the PEI information broadcast the system information including the PEI transmission area information. Here, the area (hereinafter, referred to as “PEI transmission area”) to which the PEI is transmitted, which is indicated by the PEI transmission area information may be any one of the following two patterns. It should be noted that the PEI transmission area can also be referred to as a “cell to which the PEI is transmitted” or a “PEI transmission cell”.

Transmission area pattern 1: the PEI information is transmitted in a cell (hereinafter, referred to as “last cell” or “last used cell”) in which the RRC connection is released. The last cell may be referred to as a cell in which the terminal 10 has transitioned from the connected state to the idle state or the inactive state, or a cell that has received the RRC release message. In addition, the cell may be referred to as a cell in which the terminal 10 has last transitioned from the connected state to the idle state or the inactive state, or a cell in which the terminal 10 has last received the RRC release message.

Transmission area pattern 2: PEI information is transmitted in a cell included in the RNA or the TAI list. In the pattern, the terminal 10 may recognize that the PEI information is transmitted in each cell in the RNA in a case where the terminal 10 is in the inactive state, and may recognize that the PEI information is transmitted in each cell in the TAI list in a case where the terminal 10 is in the idle state.

In the present embodiment, the terminal 10 may perform any one or both of a method (hereinafter, referred to as a “method based on the broadcast information of the serving cell”) of controlling whether or not to monitor the PEI DCI according to the PEI transmission area information broadcasted in the serving cell and a method (hereinafter, referred to as a “method based on the broadcast information of the last cell”) of controlling whether or not to monitor the PEI DCI according to the PEI transmission area information broadcasted in the last cell.

Hereinafter, the “method based on the broadcast information of the serving cell” and the “method based on the broadcast information of the last cell” will be specifically described. In the following description, the terminal 10 is assumed to transition to the idle state or the inactive state in the cell C1 (that is, the cell C1 is the last cell), and then to reselect the cell C2 while moving in the idle state or the inactive state.

### Method Based on Broadcast Information of Serving Cell

In a case in which the serving cell corresponds to the PEI transmission area indicated by the PEI transmission area information broadcasted in the serving cell, the terminal 10 assumes that the PEI information is transmitted in the serving cell. Meanwhile, in a case in which the serving cell does not correspond to the PEI transmission area indicated by the PEI transmission area information broadcasted in the serving cell, the terminal 10 assumes that the PEI information is not transmitted in the serving cell.

Case in which PEI Transmission Area Information of Transmission Area Pattern 1 is Broadcasted in Serving Cell

In this case, in a case in which the serving cell is the last cell, the terminal 10 assumes that the PEI information is transmitted in the serving cell. Meanwhile, in a case in which the serving cell is not the last cell, the terminal 10 assumes that the PEI information is not transmitted in the serving cell.

For example, in FIG. 4, it is assumed that the PEI transmission area information indicating the transmission area pattern 1 is broadcasted in each of the cells C1 and C2. First, the terminal 10 acquires the PEI transmission area information broadcasted in the cell C1 while the terminal 10 serves in the cell C1. Subsequently, the terminal 10 assumes the presence or absence of transmission of the PEI information based on the acquired PEI transmission area information. Since the serving cell (cell C1) is the last cell, the terminal 10 assumes that the PEI information is transmitted while the terminal 10 serves in the cell C1, and monitors the PEI·DCI (first downlink control information) in the PEI search space (first search space set) of the PEI-O.

Subsequently, the terminal 10 reselects the cell C2 and acquires the PEI transmission area information broadcasted in the cell C2. The terminal 10 assumes the presence or absence of the transmission of the PEI information based on the acquired PEI transmission area information. Since the serving cell (cell C2) is not the last cell, the terminal 10 assumes that the PEI information is not transmitted while the terminal 10 servers in the cell C2, and monitors the paging DCI (second downlink control information) in the paging search space (second search space set) of the PO without monitoring the PEI DCI.

Case in which PEI Transmission Area Information of Transmission Area Pattern 2 is Broadcasted in Serving Cell

In this case, in a case in which the serving cell is included in the RNA or the TAI list, the terminal 10 assumes that the PEI information is transmitted in the serving cell. Meanwhile, in a case in which the serving cell is not included in the RNA or the TAI list, the terminal 10 assumes that the PEI information is not transmitted in the serving cell.

For example, in FIG. 4, it is assumed that the PEI transmission area information indicating the transmission area pattern 2 is broadcasted in each of the cells C1 and C2. In addition, it is assumed that the cells C1 and C2 are included in the cells in the RNA or the TAI list configured in the terminal 10. First, the terminal 10 acquires the PEI transmission area information broadcasted in the cell C1 while the terminal 10 serves in the cell C1. Subsequently, the terminal 10 assumes the presence or absence of transmission of the PEI information based on the acquired PEI transmission area information. Since the serving cell (cell C1) is included in the RNA or the TAI list, the terminal 10 assumes that the PEI information is transmitted while the terminal 10 is in the serving cell C1, and monitors the PEI DCI in the PEI search space of the PEI-O.

Subsequently, the terminal 10 reselects the cell C2 and acquires the PEI transmission area information broadcasted in the cell C2. The terminal 10 assumes the presence or absence of the transmission of the PEI information based on the acquired PEI transmission area information. Since the serving cell (cell C2) is included in the RNA or the TAI list, the terminal 10 assumes that the PEI information is transmitted while the terminal 10 is in the serving cell C2, and monitors the PEI DCI in the PEI search space of the PEI-O.

### Method Based on Broadcast Information of Last Cell

In a case in which the serving cell corresponds to the PEI transmission area indicated by the PEI transmission area information broadcasted by the last cell, the terminal 10 assumes that the PEI information is transmitted in the serving cell. Meanwhile, in a case in which the serving cell does not correspond to the PEI transmission area indicated by the PEI transmission area information broadcasted by the last cell, the terminal 10 assumes that the PEI information is not transmitted in the serving cell.

In the “method based on the broadcast information of the last cell”, the terminal 10 acquires and stores the PEI transmission area information broadcasted by the last cell, and continues to store the PEI transmission area information while the idle state and the inactive state are continued. In this case, the terminal 10 may not acquire the PEI transmission area information from the system information acquired in the reselected cell after acquiring the PEI transmission area information in the last cell until the terminal 10 transitions to the next connected state. The power consumption of the terminal 10 can be further reduced.

Case in which PEI Transmission Area Information of Transmission Area Pattern 1 is Broadcasted in Last Cell

In this case, in a case in which the serving cell is the last cell, the terminal 10 assumes that the PEI information is transmitted. Meanwhile, in a case in which the serving cell is not the last cell, the terminal 10 assumes that the PEI information is not transmitted in the serving cell.

For example, in FIG. 4, it is assumed that the PEI transmission area information indicating the transmission area pattern 1 is broadcasted in each of the cells C1 and C2. First, the terminal 10 acquires the PEI transmission area information broadcasted in the cell C1. Subsequently, the terminal 10 assumes the presence or absence of transmission of the PEI information based on the acquired PEI transmission area information. Since the serving cell (cell C1) is the last cell, the terminal 10 assumes that the PEI information is transmitted while the terminal 10 serves in the cell C1, and monitors the PEI DCI in the PEI search space of the PEI-O.

Subsequently, the terminal 10 reselects the cell C2. The terminal 10 assumes the presence or absence of the transmission of the PEI information based on the PEI transmission area information acquired in the last cell. Since the serving cell (cell C2) is not the last cell, it is assumed that the PEI information is not transmitted while the terminal 10 serves in the cell C2, and the paging DCI is monitored in the paging search space of the PO without monitoring the PEI DCI.

Case in which PEI Transmission Area Information of Transmission Area Pattern 2 is Broadcasted in Last Cell

In a case in which the serving cell is a cell in the RNA or the TAI list, the terminal 10 assumes that the PEI information is transmitted in the serving cell. Meanwhile, in a case in which the serving cell is not the cell in the RNA or the TAI list, the terminal 10 assumes that the PEI information is not transmitted in the serving cell For example, in FIG. 4, it is assumed that the PEI transmission area information indicating the transmission area pattern 2 is broadcasted in each of the cells C1 and C2. In addition, it is assumed that the cells C1 and C2 are included in the cells in the RNA or the TAI list configured in the terminal 10. First, the terminal 10 acquires the PEI transmission area information broadcasted in the cell C1. Subsequently, the terminal 10 assumes the presence or absence of transmission of the PEI information based on the acquired PEI transmission area information. Since the serving cell (cell C1) is included in the RNA or the TAI list, the terminal 10 assumes that the PEI information is transmitted while the terminal 10 is in the serving cell C1, and monitors the PEI DCI in the PEI search space of the PEI-O Subsequently, the terminal 10 reselects the cell C2. The terminal 10 assumes the presence or absence of the transmission of the PEI information based on the PEI transmission area information acquired in the last cell. Since the serving cell (cell C2) is included in the RNA or the TAI list, the terminal 10 assumes that the PEI information is transmitted while the terminal 10 is in the serving cell C2, and monitors the PEI DCI in the PEI search space of the PEI-O.

### Supplementary Notes

In a case in which the terminal 10 in the inactive state selects a cell that does not belong to the RNA configured in the terminal 10 in the reselection procedure, the terminal 10 in the inactive state transmits the RNA update to the base station 20, so that the RNA configured in the terminal 10 is updated to the RNA including the selected cell. Similarly, in a case in which the terminal 10 in the idle state selects the cell that does not belong to the TAI list configured in the terminal 10 in the reselection procedure, the mobility registration update procedure is performed, so that the TAI list configured in the terminal 10 is updated to the TAI list including the selected cell. That is, in a case in which the RNA and the TAI list are normally updated, the case in which the serving cell is not included in the RNA or the TAI list does not occur. Therefore, in the “method based on broadcast information of the serving cell” and the “method based on the broadcast information of the last cell”, in a case in which the PEI transmission area information of the transmission area pattern 2 is broadcasted in the serving cell, the terminal 10 may simply assume that the PEI information is transmitted in each cell without determining whether or not the serving cell is included in the RNA or the TAI list.

### Processing Procedure Between Terminal and Base Station

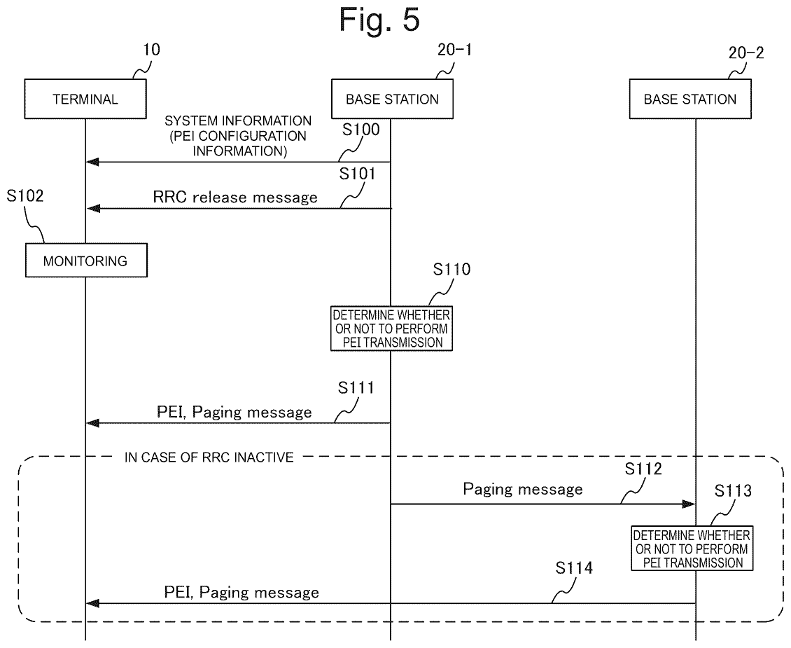

FIG. 5 is a sequence diagram illustrating an example of a processing procedure performed by the terminal 10 and the base station 20. In FIG. 5, it is assumed that the base station 20-1 forms the cell C1 and the base station 20-2 forms the cell C2. In addition, it is assumed that the terminal 10 is in a connected state and serves in the cell C1. In addition, Steps S112 to S114 of FIG. 5 are performed in a case in which the terminal 10 is in the inactive state. In addition, in FIG. 5, in a case in which the base station 20-1 and the base station 20-2 are not distinguished from each other, the base station 20 is described.

In Step S100, the terminal 10 serving in the cell C1 acquires the system information transmitted from the base station 20-1, and stores the acquired system information in the memory of the terminal 10 itself. The acquisition and storage of system information by the terminal 10 may also be referred to as configuring system information to the terminal 10. The system information includes various types of configuration information (hereinafter, referred to as “PEI configuration information” or “second information”) about the PEI. The PEI configuration information may include information indicating whether or not the cell corresponds to the transmission of PEI (whether or not the cell supports PEI). In addition, in a case in which the system information includes the PEI configuration information, it may mean that the cell corresponds to the transmission of the PEI, and in a case in which the system information does not include the PEI configuration information, it may mean that the cell does not correspond to the transmission of the PEI.

In addition, the PEI transmission area information may be included in the PEI configuration information. That is, the PEI transmission area information may be a part of various types of configuration information about the PEI. In addition, the PEI transmission area information may be information indicating explicitly or implicitly which pattern of the transmission area patterns 1 and 2 corresponds to the PEI transmission area. For example, the PEI transmission area information may be information explicitly indicating the transmission area pattern 1 or the transmission area pattern 2. Alternatively, in a case in which the PEI transmission area information is included in the PEI configuration information (or the system information), it means that the PEI is transmitted in the transmission area pattern 1, and in a case in which the PEI transmission area information is not included in the PEI configuration information (or the system information), it means that the PEI is transmitted in the transmission area pattern 2. Alternatively, in a case in which the PEI transmission area information is not included in the PEI configuration information (or the system information), it means that the PEI is transmitted in the transmission area pattern 1, and in a case in which the PEI transmission area information is included in the PEI configuration information (or the system information), it means that the PEI is transmitted in the transmission area pattern 2.

The PEI configuration information may be included in the SIB1 or may be included in the SIB2 or later. Since the SIB1 includes various types of information about the paging, such as the paging cycle, the terminal 10 can efficiently acquire the information about the paging and the PEI configuration information by receiving the SIB1.

In Step S101, in a case in which the terminal 10 is transitioned to the idle state, the base station 20 transmits a radio resource control (RRC) release message. In addition, in a case in which the terminal 10 is transitioned to the inactive state, the base station 20 transmits an RRC release message including a parameter (for example, SuspendConfig) indicating configuration information about the inactive state. The parameter may include information (for example, RAN-NotificationAreaInfo) about the RNA. The information about the RNA may be represented by a list (for example, PLMNRAN-AreaCellList) of cell identifiers of the cells included in the RNA or a list (for example, ran-AreaCodeList) of RAN area codes (RAN-AreaCode) included in the RNA. The terminal 10 receives the RRC release message and then transitions to the idle state or the inactive state, and stores that the last cell is the cell C1 (for example, stores the cell identifier of the cell C1 as the identifier of the last cell).

In Step S102, the terminal 10 that has transitioned to the idle state or the inactive state performs the monitoring of the PEI DCI and/or the monitoring of the paging DCI in accordance with the “method based on the broadcast information of the serving cell” or the “method based on the broadcast information of the last cell” described above. In a case in which the serving cell corresponds to the transmission of the PEI (for example, in a case in which the system information includes the PEI configuration information), the terminal 10 may monitor the PEI DCI in accordance with the “method based on the broadcast information of the serving cell” or the “method based on the broadcast information of the last cell”. In addition, in a case in which the serving cell does not correspond to the transmission of the PEI (for example, in a case in which the system information does not include the PEI configuration information), the terminal 10 may assume that the PEI is not transmitted in the serving cell and may perform the monitoring of the paging DCI without performing the monitoring of the PEI DCI.

In Step S110, in a case in which the base station 20-1 transmits the paging message to the terminal 10, the base station 20-1 determines whether or not to transmit the PEI information (more specifically, the PCI DCI including the PEI information) before transmitting the paging message based on the PEI transmission area information configured in the base station 20-1. Hereinafter, a method of determining whether or not to transmit the PEI information will be described in a case in which the terminal 10 is in the idle state and in a case in which the terminal 10 is in the inactive state.

Case in which Terminal is in Idle State

It is assumed that the PEI transmission area is configured to the transmission area pattern 1 (the PEI information is transmitted in the last cell) in the base station 20-1, and the information about the last cell included in the paging message received from the core network 30 indicates the cell formed by the base station 20-1. In this case, the base station 20-1 may determine to transmit the PEI information in the last cell among the cells for which the paging is performed. In addition, it is assumed that the PEI transmission area is configured to the transmission area pattern 1 in the base station 20-1 and the information about the last cell included in the paging message received from the core network 30 does not indicate the cell formed by the base station 20-1. In this case, the base station 20-1 may determine not to transmit the PEI information in the cell in which the paging is performed.

In addition, in a case in which the PEI transmission area is configured to the transmission area pattern 2 (the PEI information is transmitted in the TAI list or the RNA) in the base station 20, the base station 20 may determine to transmit the PEI information in the cell for which the paging is performed. That is, in the example of FIG. 5, the base station 20-1 may determine to transmit the PEI information in a case in which the PEI transmission area is configured to the transmission area pattern 2.

Case in which Terminal is in Inactive State

In a case in which the PEI transmission area is configured to the transmission area pattern 1 (the PEI information is transmitted in the last cell) in the base station 20-1, the base station 20-1 may determine to transmit the PEI information in the last cell among the cells in which the paging is performed (in the example of FIG. 5, since the cell C1 is the last cell, the base station 20-1 determines to transmit the PEI information in the cell C1). In addition, the base station 20-1 may determine not to transmit the PEI information in the cell other than the last cell. In addition, in a case in which the PEI transmission area is configured to the transmission area pattern 2 (the PEI information is transmitted in the TAI list or the RNA) in the base station 20-1, it may be determined to transmit the PEI information to the cell that performs the paging, regardless of which cell is the last cell.

In Step S111, the base station 20-1 transmits the PEI DCI (in a case in which the base station 20-1 corresponds to the sub-group, PEI DCI including the sub-group information indicating the sub-group of the terminal 10) to the PEI search space of the PEI-O in the cell in which it is determined to transmit the PEI information. In addition, the base station 20-1 transmits the paging DCI in the paging search space of the PO corresponding to the PEI DCI (in a case in which the base station 20-1 corresponds to the sub-group, the PO corresponding to the sub-group of the terminal 10), and transmits the paging message including the terminal identifier of the terminal 10 via the PDSCH scheduled by the paging DCI.

Meanwhile, the base station 20-1 transmits the paging DCI in the paging search space of the PO and transmits the paging message including the terminal identifier of the terminal 10 through the PDSCH scheduled by the paging DCI in the cell in which it is determined not to transmit the PEI information.

In Step S112, since the base station 20-1 performs the paging on the other base station 20-2 that forms each cell in the RNA, the paging message is transmitted to the base station 20-2.

In Step S113, the base station 20-2 determines whether or not to transmit the PEI information before transmitting the paging message. It should be noted that, since the paging to the terminal 10 in the inactive state is performed with the base station 20 that has transitioned the terminal 10 to the inactive state as a starting point, the cell of the base station 20 that has received the paging message from the other base station 20 does not correspond to the last cell. Therefore, in a case in which the PEI transmission area is configured to the transmission area pattern 1 (the PEI information is transmitted in the last cell) in the system information of the base station 20-2, the base station 20-2 that has received the paging message from the base station 20-1 may determine not to transmit the PEI information in the cell in which the paging is performed.

In addition, in a case in which the PEI transmission area is configured to the transmission area pattern 2 (the PEI information is transmitted in the TAI list or the RNA) in the base station 20, it may be determined to transmit the PEI information in the cell for which the paging is performed. That is, in the example of FIG. 5, the base station 20-2 may determine to transmit the PEI information in a case in which the PEI transmission area is configured to the transmission area pattern 2.

In Step S114, the base station 20-2 transmits the PEI DCI (PEI DCI including the sub-group information indicating the sub-group of the terminal 10 in a case in which the base station 20-2 corresponds to the sub-group) in the PEI search space of the PEI-O in the cell in which it is determined to transmit the PEI information. In addition, the base station 20-2 transmits the paging DCI in the paging search space of the PO corresponding to the PEI DCI (in a case in which the base station 20-2 corresponds to the sub-group, the PO corresponding to the sub-group of the terminal 10), and transmits the paging message including the terminal identifier of the terminal 10 through the PDSCH scheduled by the paging DCI.

Meanwhile, the base station 20-2 transmits the paging DCI in the paging search space of the PO and transmits the paging message including the terminal identifier of the terminal 10 through the PDSCH scheduled by the paging DCI in the cell in which it is determined not to transmit the PEI information.

According to the processing procedure described above, the terminal 10 is operated to perform the monitoring of the PEI-O in the configured PEI transmission area, and not to perform the monitoring of the PEI-O outside the configured PEI transmission area. In addition, the base station 20 is operated to transmit the PEI information within a range of the configured PEI transmission area, and not to transmit the PEI information outside the range of the configured PEI transmission area. As a result, the terminal 10 and the base station 20 can recognize the cell to which the PEI information is transmitted, and can appropriately control the transmission and reception of the PEI information. In addition, according to the “method based on the broadcast information of the serving cell”, the PEI transmission area can be indicated for each cell, so that the PEI transmission presence/absence can be flexibly indicated according to the load of each cell. Meanwhile, according to the “method based on the broadcast information of the last cell”, the terminal 10 need only check the system information in the cell that is last in the connected state, and thus it is not necessary to check the PEI transmission area information included in the system information of the cell that is reselected after transitioning to the idle state or the inactive state, so that it is possible to further suppress the power consumption of the terminal 10.

### Specification Change Example

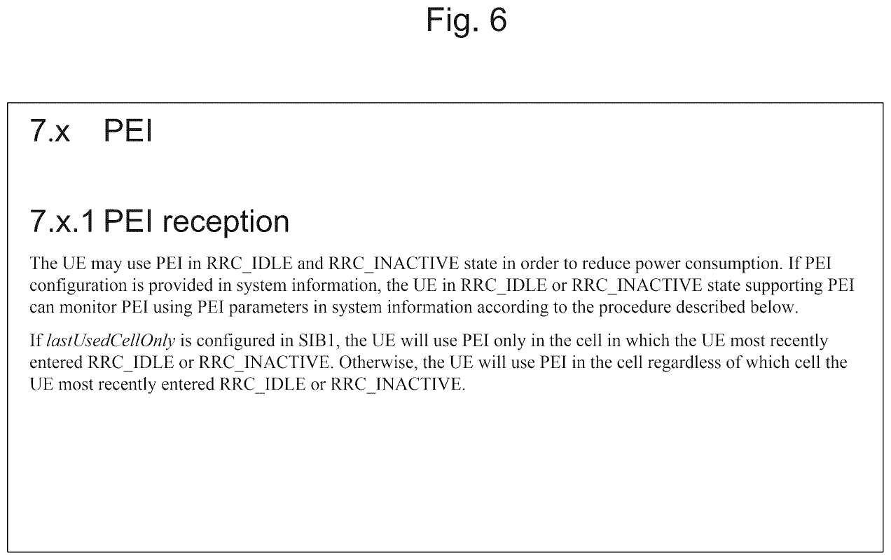

FIG. 6 is a diagram illustrating a specification change example (1) of a 3GPP specification (TS38.304). This specification change example corresponds to the “method based on the broadcast information of the serving cell”. It should be noted that the following specification change examples are merely examples, and the specification change examples are not limited to those described below. As illustrated in FIG. 6, in a case in which the PEI configuration information is included in the system information, the terminal 10 may monitor the PEI information by using the PEI parameter (various parameters included in the PEI configuration information) included in the system information. In addition, in a case in which “lastUsedCellOnly” is configured in SIB1, the terminal 10 may use the PEI only in the cell that has most recently transitioned to the idle state or the inactive state. Meanwhile, in a case in which “lastUsedCellOnly” is not configured in SIB1, the terminal 10 may use the PEI regardless of whether or not the cell is the cell that has most recently transitioned to the idle state or the inactive state. It should be noted that whether the PEI transmission area information indicates the transmission area pattern 1 (PEI transmission in the last cell) or indicates the transmission area pattern 2 (PEI transmission in the TAI list or the RNA) may be determined by whether or not the “lastUsedCellOnly” parameter is configured in the SIB1. For example, the transmission area pattern 1 may be indicated in a case in which the “lastUsedCellOnly” parameter is configured in the SIB1, and the transmission area pattern 2 may be indicated in a case in which the “lastUsedCellOnly” parameter is not configured in the SIB1.

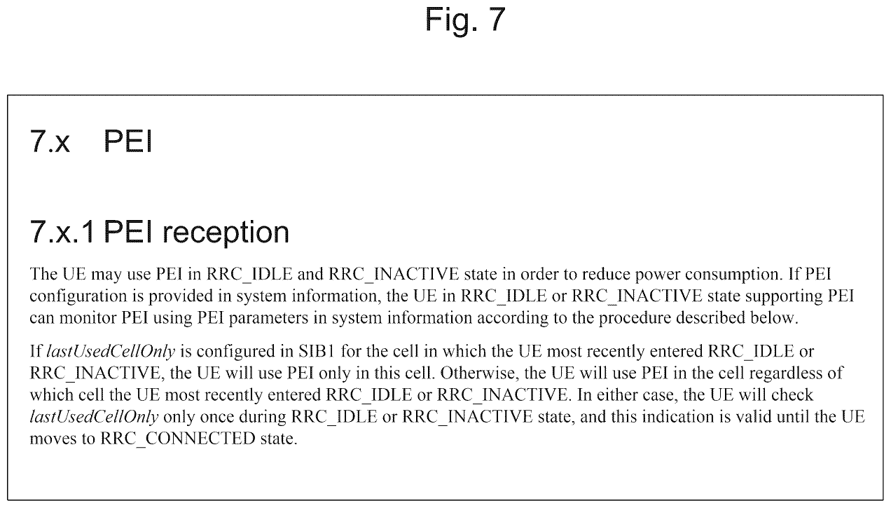

FIG. 7 is a diagram illustrating a specification change example (2) of the 3GPP specification (TS38.304). This specification change example corresponds to the “method based on the broadcast information of the last cell”. As illustrated in FIG. 7, in a case in which the system information includes the PEI configuration information, the terminal 10 may monitor the PEI information by using the PEI parameter (various parameters included in the PEI configuration information) included in the system information. In addition, in a case in which “lastUsedCellOnly” is configured in the SIB1 of the cell that has most recently transitioned to the idle state or the inactive state, the terminal 10 may use the PEI only in the cell (the cell that has most recently transitioned to the idle state or the inactive state). Meanwhile, in a case in which “lastUsedCellOnly” is not configured in the SIB1 of the cell that has most recently transitioned to the idle state or the inactive state, the terminal 10 may use the PEI regardless of whether or not the cell is the cell that has most recently transitioned to the idle state or the inactive state. It should be noted that the terminal 10 may check whether or not “lastUsedCellOnly” is configured in SIB1 only once (for example, only once in a cell that has transitioned to the idle state or the inactive state) during the idle state or the inactive state, and the instruction based on the configuration may be valid until the terminal 10 transitions to the connected state.

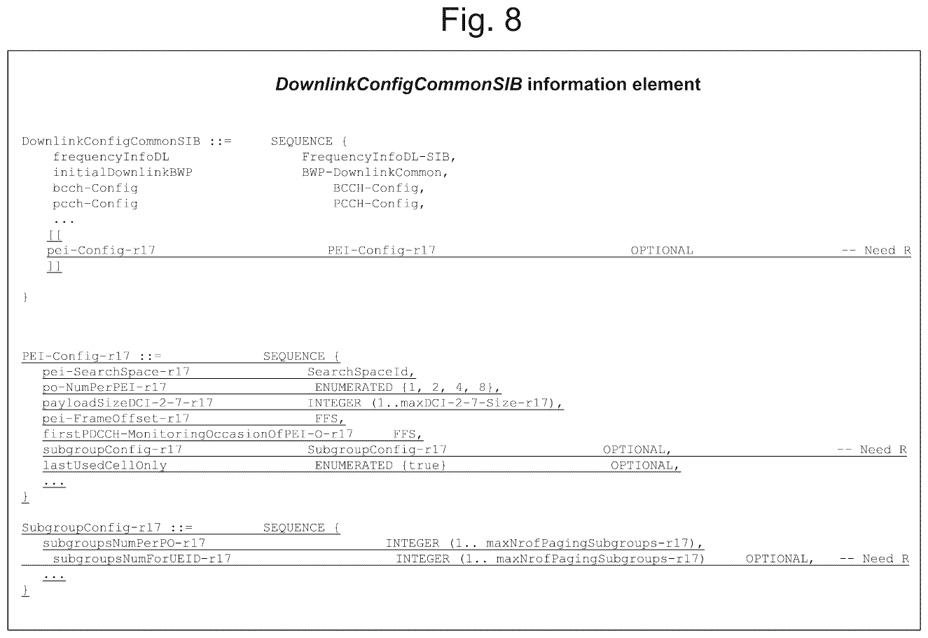

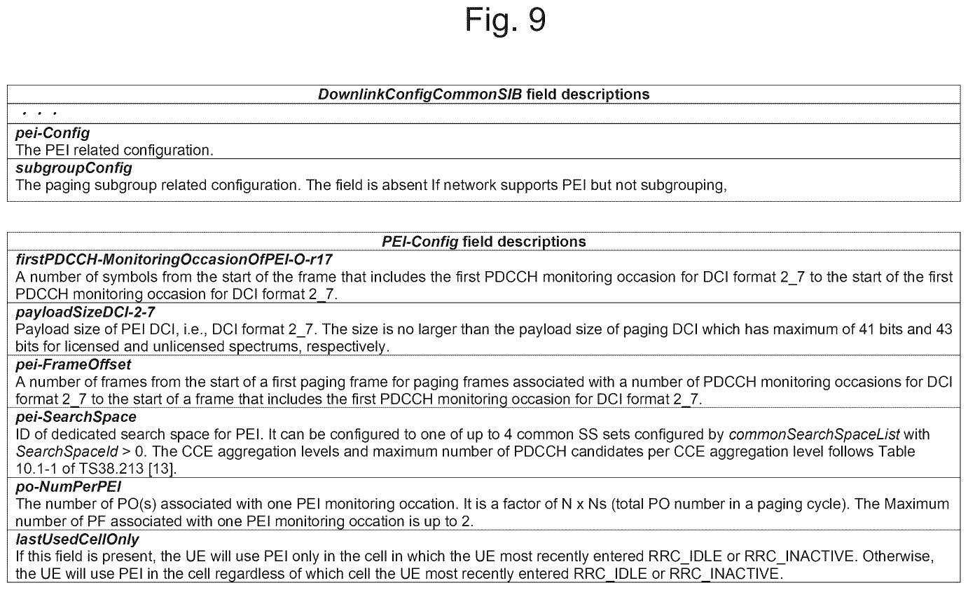

FIGS. 8 and 9 are diagrams illustrating a specification change example of the 3GPP specification (TS38.331). In addition, FIG. 9 illustrates an explanatory example regarding the added information in FIG. 8.

As illustrated in FIG. 8, the “DownlinkConfigCommonSIB” included in the SIB1 includes the PEI configuration information (for example, pei-Config-r17), and the PEI transmission area information (for example, lastUsedCellOnly) may be included in the PEI configuration information. In a case in which the SIB1 includes the PEI configuration information (for example, pei-Config-r17), it may be indicated that the PEI transmission is supported in the serving cell. In addition, in a case in which the PEI transmission area information (for example, lastUsedCellOnly) exists, the terminal 10 may use the PEI only in the cell that has most recently transitioned to the idle state or the inactive state, and in a case in which it's not (in a case in which lastUsedCellOnly does not exist), the terminal 10 may use the PEI regardless of whether or not the cell is the cell that has most recently transitioned to the idle state or the inactive state.

### Configuration of Wireless Communication System

Next, a configuration of each apparatus of the wireless communication system 1 described above will be described. The following configuration illustrates a necessary configuration in describing the present embodiment and does not exclude each apparatus including a functional block other than the illustrated functional blocks.

### Hardware Configuration

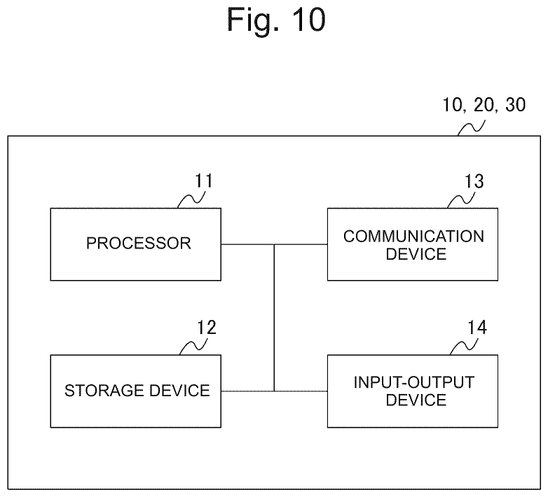

FIG. 10 is a diagram illustrating an example of a hardware configuration of each apparatus in the wireless communication system according to the present embodiment. Each apparatus (for example, the terminal 10, the base station 20, and the core network 30) in the wireless communication system 1 includes a processor 11, a storage device 12, a communication device 13 that performs wired or wireless communication, and an input device that receives various input operations or an input-output device 14 that outputs various types of information.

The processor 11 is, for example, a central processing unit (CPU) and controls each apparatus in the wireless communication system 1. The processor 11 may perform various types of processing described in the present embodiment by reading out a program from the storage device 12 and performing the program. Each apparatus in the wireless communication system 1 may be configured with one or a plurality of processors 11. In addition, each apparatus may be called a computer.

The storage device 12, for example, is configured with a storage such as a memory, a hard disk drive (HDD), and/or a solid state drive (SSD). The storage device 12 may store various types of information (for example, the program performed by the processor 11) necessary for performing the processing via the processor 11.

The communication device 13 is a device that performs communication through a wired and/or wireless network and may include, for example, a network card, a communication module, a chip, or an antenna. In addition, the communication device 13 may include a radio frequency (RF) device that performs processing related to an amplifier and to a radio signal and a baseband (BB) device that performs baseband signal processing.

The RF device generates a radio signal to be transmitted from the antenna by performing, for example, D/A conversion, modulation, frequency conversion, and power amplification with respect to a digital baseband signal received from the BB device. In addition, the RF device generates a digital baseband signal by performing frequency conversion, demodulation, A/D conversion, and the like with respect to a radio signal received from the antenna and transmits the digital baseband signal to the BB device.

The BB device performs processing of converting data into a digital baseband signal.

Specifically, the BB device may generate an OFDM symbol as an IFFT by mapping the data to a subcarrier and generate the digital baseband signal by inserting a CP into the generated OFDM symbol. The BB device may apply a transform precoder (DFT spreading) before mapping the data to the subcarrier.

In addition, the BB device performs processing of converting a digital baseband signal into data. Specifically, the BB device may remove the CP from the digital baseband signal input from the RF device and extract a signal of the frequency domain by performing an FFT with respect to the signal in which the CP is removed. The BB device may apply an IDFT to the signal of the frequency domain.

The input-output device 14, for example, includes an input device such as a keyboard, a touch panel, a mouse, and/or a microphone and, for example, includes an output device such as a display and/or a speaker.

The hardware configuration described above is merely an example. Each apparatus in the wireless communication system 1 may be partially omitted in the hardware described in FIG. 10 or may include hardware not described in FIG. 10. In addition, the hardware illustrated in FIG. 10 may be configured with one or a plurality of chips.

### Functional Block Configuration

### Terminal

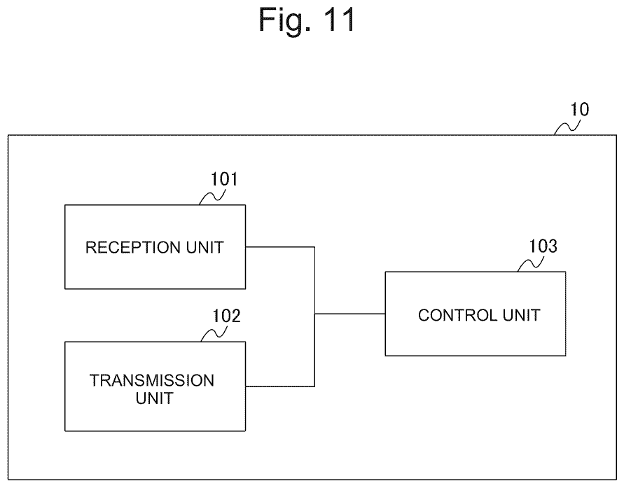

FIG. 11 is a diagram illustrating an example of a functional configuration of the terminal according to the present embodiment. As illustrated in FIG. 11, the terminal 10 includes a reception unit 101, a transmission unit 102, and a control unit 103. The functional configuration illustrated in FIG. 11 is merely an example. Any functional distinction and any names of functional units with which the operation according to the present embodiment can be performed may be used. In addition, the reception unit 101 and the transmission unit 102 may be collectively referred to as a communication unit.

All or a part of the functions implemented by the reception unit 101 and by the transmission unit 102 can be implemented using the communication device 13. In addition, all or a part of the functions implemented by the reception unit 101 and by the transmission unit 102 and the control unit 103 can be implemented by performing the program stored in the storage device 12 via the processor 11. In addition, the program can be stored in a storage medium. The storage medium in which the program is stored may be a non-transitory computer readable medium. The non-transitory computer readable medium is not particularly limited and, for example, may be a storage medium such as a USB memory or a CD-ROM.

The reception unit 101 receives a signal (for example, the DL signal and/or a sidelink signal). In addition, the reception unit 101 may receive information and/or data transmitted through the signal. Here, the term “receive”, for example, may include performing processing related to reception such as at least one of reception of a radio signal, demapping, demodulation, decoding, monitoring, or measurement. The DL signal may include at least one of, for example, the PDSCH, the PDCCH, a downlink reference signal, the synchronization signal, or the PBCH.

The reception unit 101 detects the DCI by monitoring the PDCCH candidates in the search space. The reception unit 101 may receive DL data through the PDSCH scheduled using the DCI. The DL data may include downlink user data and/or control information of a higher layer (for example, parameters of at least one of the MAC layer, an RRC layer, or the non access stratum (NAS) layer). The reception unit 101 may receive the system information through the PBCH and/or the PDSCH.

The transmission unit 102 transmits a signal (for example, the UL signal and/or the sidelink signal). In addition, the transmission unit 102 may transmit information and/or data transmitted through the signal. Here, the term “transmit”, for example, may include performing processing related to transmission such as at least one of encoding, modulation, mapping, or transmission of a radio signal. The UL signal may include at least one of, for example, the PUSCH, the PRACH, the PUCCH, or an uplink reference signal.

The transmission unit 102 may transmit UL data through the PUSCH scheduled using the DCI received by the reception unit 101. Uplink user data and/or control information (for example, parameters of at least one of the MAC layer, the RRC layer, or the NAS layer) of a higher layer may be transmitted in the UL data.

The control unit 103 performs various controls in the terminal 10. Specifically, the control unit 103 may control the operation of the terminal 10 based on information (for example, the parameters of the RRC layer) about various types of configuration received by the reception unit 101 from the base station 20 or from other terminals 10. Operating the terminal 10 based on the information may be synonymous with “configuring the configuration information in the terminal 10”.

The control unit 103 may control reception of the signal in the reception unit 101. In addition, the control unit 103 may control transmission of the signal in the transmission unit 102. The control unit 103 may determine whether to apply the transform precoder to the signal transmitted by the transmission unit 102.

In the present embodiment, the terminal 10 may include the reception unit 101 that receives the system information including the second information (for example, PEI configuration information, and the like) about the cell to which the first information (for example, PEI information, and the like) about the paging in one or the plurality of paging occasions is transmitted, and the control unit 103 that, in a case in which the terminal 10 is in the idle state or the inactive state, controls whether or not to monitor the downlink control information (for example, the PEI DCI, the first downlink control information, and the like) including the first information in the serving cell, based on the system information received by the serving cell or the cell that has transitioned to the idle state or the inactive state (or based on the second information included in the system information). It should be noted that the method of controlling whether or not to monitor the first downlink control information based on the system information received by the serving cell corresponds to the “method based on broadcast information of the serving cell”. In addition, the method of controlling whether or not to monitor the first downlink control information based on the system information received by the cell that has transitioned to the idle state or the inactive state corresponds to the “method based on the broadcast information of the last cell”.

In a case in which the information (for example, PEI transmission area information indicating the transmission area pattern 1) indicating that the cell to which the first information is transmitted is the cell that has transitioned to the idle state or the inactive state is configured in the second information included in the system information received by the serving cell, the control unit 103 may monitor the downlink control information including the first information in the serving cell when the serving cell is the same as the cell that has transitioned to the idle state or the inactive state, and may not monitor the downlink control information including the first information in the serving cell when the serving cell is not the same as the cell that has transitioned to the idle state or the inactive state. The processing corresponds to a case in which the PEI transmission area information of the transmission area pattern 1 is broadcasted in the serving cell in the “method based on the broadcast information of the serving cell”.

In a case in which the information (for example, PEI transmission area information indicating the transmission area pattern 2) indicating that the cell to which the first information is transmitted is the cell in the RAN notification area or the cell in the tracking area list is configured in the second information included in the system information received by serving cell, the control unit 103 may monitor the downlink control information including the first information in the serving cell, regardless of whether or not the serving cell is the same as the cell that has transitioned to the idle state or the inactive state. The processing corresponds to the case in which the PEI transmission area information of the transmission area pattern 2 is broadcasted in the serving cell in the “method based on the broadcast information of the serving cell”.

In a case in which the information indicating that the cell to which the first information is transmitted is the cell that has transitioned to the idle state or the inactive state is not configured in the second information included in the system information received by the serving cell, the control unit 103 may monitor the downlink control information including the first information in the serving cell, regardless of whether or not the serving cell is the same as the cell that has transitioned to the idle state or the inactive state. In addition, in a case in which the system information includes information indicating that the cell is the cell that supports transmission of the first information, and the information indicating that the cell to which the first information is transmitted is the cell that has transitioned to the idle state or an inactive state is not configured in the second information included in the system information received by the serving cell, the control unit 103 may monitor the downlink control information including the first information in the serving cell regardless of whether or not the serving cell is the same as the cell that has transitioned to the idle state or the inactive state. In a case in which the PEI transmission area information is not included in the PEI configuration information (or the system information) in the “method based on the broadcast information of the serving cell”, the processing corresponds to the PEI transmission area indicating the transmission area pattern 2.

In a case in which the information indicating that in a case in which the information indicating that the cell to which the first information is transmitted is the cell that has transitioned to the idle state or the inactive state is configured in the second information included in the system information received by the cell that has transitioned to the idle state or the inactive state, the control unit 103 may monitor the downlink control information including the first information in the serving cell when the serving cell is the same as the cell that has transitioned to the idle state or the inactive state, and may not monitor the downlink control information including the first information in the serving cell when the serving cell is not the same as the cell that has transitioned to the idle state or the inactive state. The processing corresponds to a case in which the PEI transmission area information of the transmission area pattern 1 is broadcasted in the last cell in the “method based on the broadcast information of the last cell”.

In a case in which the information indicating that the cell to which the first information is transmitted is the cell in the RAN notification area or the cell in a tracking area list is configured in the second information included in the system information received by the cell that has transitioned to the idle state or the inactive state, the control unit 103 may monitor the downlink control information including the first information in the serving cell, regardless of whether or not the serving cell is the same as the cell that has transitioned to the idle state or the inactive state. The processing corresponds to a case in which the PEI transmission area information of the transmission area pattern 2 is broadcasted in the last cell in the “method based on the broadcast information of the last cell”.

In a case in which the information indicating that the cell to which the first information is transmitted is the cell that has transitioned to the idle state or the inactive state is not configured in the second information included in the system information received by the cell that has transitioned to the idle state or the inactive state, the control unit 103 may monitor the downlink control information including the first information in the serving cell, regardless of whether or not the serving cell is the same as the cell that has transitioned to the idle state or the inactive state. In addition, in a case where the system information includes the configuration information about the first information and the information indicating that the cell to which the first information is transmitted is the cell that has transitioned to the idle state or the inactive state is not configured in the second information included in the system information received by the cell that has transitioned to the idle state or the inactive state, the control unit 103 may monitor the downlink control information including the first information in the serving cell, regardless of whether or not the serving cell is the same as the cell that has transitioned to the idle state or the inactive state. The processing corresponds to the PEI transmission area indicating the transmission area pattern 2 in a case in which the PEI transmission area information does not include the PEI configuration information (or the system information) in the “method based on the broadcast information of the last cell”.

Until the terminal transitions to a connected state after the control unit acquires information (for example, PEI transmission area information) about the cell to which the first information is transmitted from the system information received by the cell that has transitioned to the idle state or the inactive state, the control unit 103 may not acquire the information about the cell to which the first information is transmitted from the system information received by the serving cell.

In a case in which the downlink control information is received by monitoring the downlink control information including the first information, the control unit 103 may control the monitoring of the information about scheduling of the downlink shared channel for transmitting the paging message in the paging occasion and/or the downlink control information (for example, the paging DCI or the second downlink control information) including the information about the short message, based on the first information. In addition, in a case in which the downlink control information including the first information is not monitored, the control unit 103 may control the monitoring of the information about the scheduling of the downlink shared channel for transmitting the paging message in the paging occasion and/or the downlink control information including the information about the short message.

### Base Station

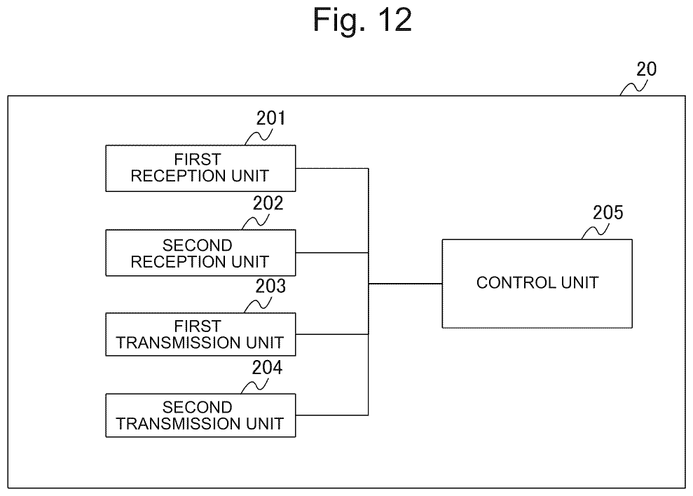

FIG. 12 is a diagram illustrating an example of a functional block configuration of the base station according to the present embodiment. As illustrated in FIG. 12, the base station 20 includes a first reception unit 201, a second reception unit 202, a first transmission unit 203, a second transmission unit 204, and a control unit 205. The functional configuration illustrated in FIG. 12 is merely an example. Any functional distinction and any names of functional units with which the operation according to the present embodiment can be performed may be used. In addition, the first reception unit 201 and the second reception unit 202 may be collectively referred to as a reception unit. In addition, the first transmission unit 203 and the second transmission unit 204 may be collectively referred to as a transmission unit. In addition, the first reception unit 201, the second reception unit 202, the first transmission unit 203, and the second transmission unit 204 may be collectively referred to as a communication unit.

All or some of the functions implemented by the first reception unit 201, the second reception unit 202, the first transmission unit 203, and the second transmission unit 204 can be implemented by using the communication device 13. For example, the first reception unit 201 and the first transmission unit 203 may be implemented by using the communication device 13 related to the wireless network, and the second reception unit 202 and the second transmission unit 204 may be implemented by using the communication device 13 related to the wired network. In addition, all or some of the functions implemented by the first reception unit 201, the second reception unit 202, the first transmission unit 203, and the second transmission unit 204, and the control unit 205 can be implemented by performing the program stored in the storage device 12 by the processor 11. In addition, the program can be stored in a storage medium. The storage medium in which the program is stored may be a non-transitory computer readable medium. The non-transitory computer readable medium is not particularly limited and, for example, may be a storage medium such as a USB memory or a CD-ROM.

The reception unit 201 receives a signal (for example, the UL signal and/or the sidelink signal). In addition, the reception unit 201 may receive information and/or data (for example, the UL data) transmitted through the signal.

The second reception unit 202 receives a signal (for example, a C-plane signal and a U-plane signal) from another base station 20 or the core network 30.

The first transmission unit 203 transmits a signal (for example, the DL signal and/or the sidelink signal). In addition, the first transmission unit 203 may transmit information and/or data (for example, the DL data) transmitted through the signal.

The second transmission unit 204 transmits the signal (for example, a C-plane signal and a U-plane signal) to the other base station 20 or the core network 30.

The control unit 205 performs various types of control for communication with the terminal 10, the other base station 20, and the core network 30. Specifically, the control unit 205 may determine information about various types of configuration of which the terminal 10 is informed. Transmitting the information to the terminal 10 may be synonymous with “configuring the information in the terminal”.

The control unit 205 may control the reception of the signals in the first reception unit 201 and the second reception unit 202. In addition, the control unit 205 may control the transmission of the signal in the first transmission unit 203 and the second transmission unit 204.

In the present embodiment, the base station 20 may include the first transmission unit 203 (transmission unit) that transmits system information including the second information (for example, PEI configuration information or PEI transmission area information) about the cell to which the first information (for example, PEI information) about the paging in one or the plurality of paging occasions is transmitted, and the control unit 205 that controls whether or not to transmit the downlink control information (for example, PEI DCI) including the first information to the terminal in the idle state or the inactive state based on the second information.

### Supplement

The PEI in the above-described embodiment may be referred to as a paging sub-group indicator.

Various signals, information, and parameters in the embodiment may be signaled in any layer. That is, the various signals, information, and parameters may be replaced with signals, information, and parameters of any layer such as a higher layer (for example, the NAS layer, the RRC layer, and the MAC layer) and a lower layer (for example, the physical layer). In addition, informing an apparatus of given information is not limited to explicit informing and may be implicitly performed (for example, without informing the apparatus of information or using other types of information).

In addition, names of various signals, information, parameters, IEs, channels, time units, and frequency units in the embodiment are merely an example and may be replaced with other names. For example, a slot may have any name of a time unit having a given number of symbols. In addition, an RB may have any name of a frequency unit having a given number of subcarriers. In addition, “first . . . ” and “second . . . ” are merely for identifying a plurality of pieces of information, signals, or function blocks, and the order thereof may be appropriately changed. For example, the “PEI information” and the “PEI configuration information” may be referred to as “second information” and “first information”, respectively. In addition, “PEI DCI” and “paging DCI” may be referred to as “second downlink control information” and “first downlink control information”, respectively. In addition, the PEI search space of the PEI-O and the paging search space of the PO may be referred to as a “second search space set” and a “first search space set”, respectively. In addition, the “base station 20-1” and the “base station 20-2” may be referred to as a “second base station” and a “first base station”, respectively.

For example, in the embodiment, each of the PDSCH, the PUSCH, the PDCCH, the PBCH, the PRACH, and the like has been illustrated in the present embodiment as examples of a physical channel for transmitting the DL data, a physical channel for transmitting the UL data, a physical channel for transmitting the DCI, a physical channel for transmitting broadcast information, and a physical channel for transmitting the RA preamble. However, the physical channels are not limited to the illustrated names as long as the physical channels have the same functions. In addition, these physical channels may be replaced with transport channels to which the physical channels are mapped. In addition, each of the PDSCH, the PUSCH, the PDCCH, the PBCH, the PRACH, and the like may be replaced with a transport channel (for example, at least one of a downlink shared channel (DL-SCH), an uplink shared channel (UL-SCH), a broadcast channel (BCH), and a random access channel (RCH)) and the like mapped to a physical channel. In addition, these transport channels may be replaced with logical channels to which the transport channels are mapped. In addition, the DL data and the UL data may be downlink data and uplink data, respectively, and the data may include user data and control information of a higher layer (for example, the RRC parameter, the medium access control (MAC) parameter, or the like).

In addition, the purpose (for example, RedCap, IoT, or the like) of the terminal 10 in the embodiment is not limited to the illustrated purposes and may be used for any purposes (for example, eMBB, URLLC, device-to-device (D2D), vehicle-to-everything (V2X), or the like) as long as the terminal 10 has the same functions. In addition, forms of various types of information are not limited to the embodiment and may be changed to a bit representation (0 or 1), a truth value (boolean; true or false), an integer value, a text, and the like, as appropriate. In addition, singular forms and plural forms in the embodiment may be changed from each other.

The embodiment described above is for easy understanding of the present disclosure and is not to be interpreted as limiting the present disclosure. The flowcharts, sequences, each element in the embodiment and positioning of the elements, indexes, conditions, and the like described in the embodiment are not limited to the illustration and can be changed, as appropriate. In addition, at least some of the configurations described in the embodiment can be partially replaced or combined with each other.

### Addendum

The present embodiment can be expressed as follows.

### Addendum 1

A terminal including:
a reception unit configured to receive system information including second information about a cell to which first information about paging in one or a plurality of paging occasions is transmitted; and
a control unit configured to, in a case in which the terminal is in an idle state or an inactive state, control whether or not to monitor downlink control information including the first information in a serving cell, based on the system information received by the serving cell or a cell that has transitioned to the idle state or the inactive state.

### Addendum 2

The terminal according to Addendum 1, in which in a case in which information indicating that the cell to which the first information is transmitted is a cell that has transitioned to the idle state or the inactive state is configured in the second information included in the system information received by the serving cell,
the control unit monitors the downlink control information including the first information in the serving cell when the serving cell is the same as the cell that has transitioned to the idle state or the inactive state, and
does not monitor the downlink control information including the first information in the serving cell when the serving cell is not the same as the cell that has transitioned to the idle state or the inactive state.

### Addendum 3

The terminal according to Addendum 1 or 2, in which in a case in which information indicating that the cell to which the first information is transmitted is a cell in an RAN notification area or a cell in a tracking area list is configured in the second information included in the system information received by the serving cell, the control unit monitors the downlink control information including the first information in the serving cell, regardless of whether or not the serving cell is the same as the cell that has transitioned to the idle state or the inactive state.

### Addendum 4

The terminal according to any one of Addenda 1 to 3, in which in a case in which the information indicating that the cell to which the first information is transmitted is the cell that has transitioned to the idle state or the inactive state is not configured in the second information included in the system information received by the serving cell, the control unit monitors the downlink control information including the first information in the serving cell, regardless of whether or not the serving cell is the same as the cell that has transitioned to the idle state or the inactive state.

### Addendum 5

The terminal according to Addendum 1, in which in a case in which information indicating that the cell to which the first information is transmitted is the cell that has transitioned to the idle state or the inactive state is configured in the second information included in the system information received by the cell that has transitioned to the idle state or the inactive state, the control unit monitors the downlink control information including the first information in the serving cell when the serving cell is the same as the cell that has transitioned to the idle state or the inactive state, and does not monitor the downlink control information including the first information in the serving cell when the serving cell is not the same as the cell that has transitioned to the idle state or the inactive state.

### Addendum 6

The terminal according to Addendum 1 or 5, in which in a case in which information indicating that the cell to which the first information is transmitted is a cell in an RAN notification area or a cell in a tracking area list is configured in the second information included in the system information received by the cell that has transitioned to the idle state or the inactive state, the control unit monitors the downlink control information including the first information in the serving cell, regardless of whether or not the serving cell is the same as the cell that has transitioned to the idle state or the inactive state.

### Addendum 7

The terminal according to Addenda 1, 5, or 6, in which in a case in which information indicating that the cell to which the first information is transmitted is the cell that has transitioned to the idle state or the inactive state is not configured in the second information included in the system information received by the cell that has transitioned to the idle state or the inactive state, the control unit monitors the downlink control information including the first information in the serving cell, regardless of whether or not the serving cell is the same as the cell that has transitioned to the idle state or the inactive state.

### Addendum 8

The terminal according to Addenda 1, and 5 to 7, in which until the terminal transitions to a connected state after the control unit acquires information about the cell to which the first information is transmitted from the system information received by the cell that has transitioned to the idle state or the inactive state, the control unit does not acquire the information about the cell to which the first information is transmitted from the system information received by the serving cell.

### Addendum 9

A base station including:
a transmission unit configured to transmit system information including second information about a cell to which first information about paging in one or a plurality of paging occasions is transmitted; and
a control unit configured to control whether or not to transmit downlink control information including the first information to a terminal in an idle state or an inactive state based on the second information.

### Addendum 10

A wireless communication method performed by a terminal, the method including:
a step of receiving system information including second information about a cell to which first information about paging in one or a plurality of paging occasions is transmitted; and
a step of controlling, in a case in which the terminal is in an idle state or an inactive state, whether or not to monitor downlink control information including the first information in a serving cell, based on the system information received by the serving cell or a cell that has transitioned to the idle state or the inactive state.

### Addendum 11

A wireless communication method performed by a base station, the method including:
a step of transmitting system information including second information about a cell to which first information about paging in one or a plurality of paging occasions is transmitted; and
a step of controlling whether or not to transmit downlink control information including the first information to a terminal in an idle state or an inactive state based on the second information.

What is claimed is:

1. A terminal comprising:
receiving circuitry configured to receive, from a base station, system information including configuration information of paging early indication (PEI) in a cell, and receive, from the base station, a radio resource control (RRC) release message in the cell; and
control circuitry configured to store the cell to monitor, based on the reception of the RRC release message, a physical downlink control channel (PDCCH) for first downlink control information (DCI) including the PEI in the cell in a case where the RRC release message is a latest received RRC release message,
wherein the control circuitry is configured to control to monitor the PDCCH in the cell in a case where the configuration information of the PEI includes information for indicating to monitor the PDCCH in the case where the RRC release message is the latest received RRC release message, and
control to monitor the PDCCH in a camped cell in a case where the configuration information of the PEI does not include the information for indicating to monitor the PDCCH in the case where the RRC release message is the latest received RRC release message.

2. The terminal according to claim 1,
wherein the control circuitry is configured to control to monitor the PDCCH in a PDCCH monitoring occasion for the first DCI including the PEI,
the PEI indicates a sub-group of the terminal of a paging occasion, and
a time location of the PDCCH monitoring occasion is determined based on a paging frame and an offset from a start of the paging frame.

3. The terminal according to claim 2, wherein the control circuitry is configured to control to monitor a PDCCH for second DCI used for scheduling of a Physical Downlink Shared Channel (PDSCH) for a paging message in the paging occasion based on the sub-group of the terminal.

4. A base station comprising:
transmission circuitry configured to transmit, to a terminal, system information including configuration information of paging early indication (PEI) in a cell, and transmit, to the terminal, a radio resource control (RRC) release message in the cell; and
control circuitry configured to store the cell to transmit, based on the transmission of the RRC release message, first downlink control information (DCI) including the PEI on a physical downlink control channel (PDCCH) in the cell in a case where the RRC release message is a latest transmitted RRC release message,
wherein the control circuitry is configured to control to transmit the first DCI on the PDCCH in the cell in a case where the configuration information of the PEI includes information for indicating to monitor the PDCCH in the case where the RRC release message is the latest received RRC release message, and
control to transmit the first DCI on the PDCCH in a camped cell of the terminal in a case where the configuration information of the PEI does not include the information for indicating to monitor the PDCCH in the case where the RRC release message is the latest received RRC release message.

5. The base station according to claim 4,
wherein the control circuitry is configured to control to transmit the first DCI on the PDCCH in a PDCCH monitoring occasion for the first DCI including the PEI,
the PEI indicates a sub-group of the terminal of a paging occasion, and
a time location of the PDCCH monitoring occasion is determined based on a paging frame and an offset from a start of the paging frame.

6. The base station according to claim 5, wherein the control circuitry is configured to control to transmit on a PDCCH, second DCI used for scheduling of a Physical Downlink Shared Channel (PDSCH) for a paging massage in the paging occasion based on the sub-group of the terminal.

7. A wireless communication method of a terminal comprising:
a step of receiving, from a base station, system information including configuration information of paging early indication (PEI) in a cell;
a step of receiving, from the base station, a radio resource control (RRC) release message in the cell; and
a step of storing the cell to monitor, based on the reception of the RRC release message, a physical downlink control channel (PDCCH) for first downlink control information (DCI) including the PEI in the cell in a case where the RRC release message is a latest received RRC release message;
a step of controlling to monitor the PDCCH in the cell in a case where the configuration information of the PEI includes information for indicating to monitor the PDCCH in the case where the RRC release message is the latest received RRC release message; and
a step of controlling to monitor the PDCCH in a camped cell in a case where the configuration information of the PEI does not include the information for indicating to monitor the PDCCH in the case where the RRC release message is the latest received RRC release message.

8. The wireless communication method according to claim 7, further comprising:
a step of controlling to monitor the PDCCH in a PDCCH monitoring occasion for the first DCI including the PEI,
wherein the PEI indicates a sub-group of the terminal of a paging occasion, and
a time location of the PDCCH monitoring occasion is determined based on a paging frame and an offset from a start of the paging frame.

9. The wireless communication method according to claim 8, further comprising
a step of controlling to monitor the PDCCH for second DCI used for scheduling of a Physical Downlink Shared Channel (PDSCH) for a paging message in the paging occasion based on the sub-group of the terminal.
